(19) United States
(12) Patent Application Publication
(10) Pub. No.: US 2008/0044064 A1
(43) Pub. Date: Feb. 21, 2008

(54) METHOD FOR RECOGNIZING FACE AREA

(75) Inventor: Hsieh Chi His, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/693,727

(22) Filed: Mar. 30, 2007

(30) Foreign Application Priority Data
Aug. 15, 2006 (TW) 95129849

(51) Int. Cl. G06K 9/00

(52) U.S. Cl. 382/118

(57) ABSTRACT

A method for recognizing a face area is disclosed. The method is suitable for determining a face block from multiple images. First, the differences between the constituent colors of each pixel are compared so as to determine skin color pixels from the pixels. Then, a skin color block that covers all of the skin color pixels is found from the images and compared with an ellipse. The size and location of the ellipse is adjusted to overlap the skin color block such that the block covered by the ellipse is regarded as a face block. Through the foregoing steps, the present invention reduces the searching area for face recognition and achieves the goal of accelerating recognizing speed and increasing accuracy of face recognition.

### CROSS-REFERENCE TO RELATED APPLICATION

This application claims the priority benefit of Taiwan application serial no. 95129849, filed Aug. 15, 2006. All disclosure of the Taiwan application is incorporated herein by reference.

### BACKGROUND OF THE INVENTION

1. Field of the Invention

The present invention relates to a method for recognizing an image, and more particularly to a method of recognizing a face area.

2. Description of Related Art

With the rapid development of new technologies, all kinds of products are fabricated and sold in the market. The most recent wave of products include many types of portable electronics devices such as mobile phone, personal digital assistant, palmtop computer, each of which is capable of storing vast quantity of data and having a data processing function. With the popularization of these products, the safe protection of the data within these products is gradually become a major concern. Therefore, one of the indispensable functions required in most market products is a recognition system capable of recognizing the identity of a person.

The conventional method for recognizing personal identity includes inputting an account number and a code or inserting an identity card. These methods rely on the user to remember a code or carry an identification card. Because the user might forget the code or lost the identification card, the electronic device may not be turned on or it may be stolen. In recent years, a number of application techniques that utilize biological characteristics as the means of recognition have been developed. These application techniques include face area recognition, voice track recognition, eyeball iris compare, fingerprint or palm print compare and so on. However, face area recognition is still the most natural and most convenient method of determining a person's identity. Therefore, currently-marketed door security systems, car theft prevention devices or portable electronic devices start to implement the user identification function through a face area recognition system.

A face area recognition system must be able to extract the facial area from a complicated background. The conventional face area recognition technique, for example, the Haar cascade face area detection method utilizes a group of facial characteristic data tables to compare with a captured image and finds the area in the image closest to a human face. However, this method is able to obtain the face area after the comparisons of all the pixels in the captured image are completed. Thus, the method is not only time-consuming and computationally intensive, but the probability of having recognition error is also increased when the background is complicated.

### SUMMARY OF THE INVENTION

Accordingly, the present invention is to directed to a method for recognizing a face area. In the present method, an area in an image that covers a face area is found through recognizing a skin color area in the image and an ellipse comparing method is used to find an area matching the shape of the face area so as to achieve the purpose of finding the face location in the image.

To achieve these and other advantages, as embodied and broadly described herein, the invention provides a method for recognizing a face area suitable for recognizing a face block from a plurality of images, wherein each image includes a plurality of pixels. The method includes the following steps. First, the differences between the constituent colors of each pixel are compared so as to determine skin color pixels from the pixels. Then, a skin color block that covers all of the skin color pixels is found from the images and compared with an ellipse. The size and location of the ellipse is adjusted to overlap the skin color block such that the block covered by the ellipse is regarded as a face block.

According to the face area recognition method in the preferred embodiment of the present invention, before the step of determining the skin color pixels from the pixels, further includes comparing the differences between each image and finding the smallest rectangular block of a moving object that covers all these images to serve as a target block, and then determining the skin color pixels from the pixel area in the target block.

According to the face area recognition method in the preferred embodiment of the present invention, the step of using the differences between the images to find the moving object includes subtracting the pixel values between corresponding pixels in two adjacent images and then using a threshold method to determine the pixels with difference in pixel value as the moving object.

According to the face area recognition method in the preferred embodiment of the present invention, in the foregoing threshold method, the pixels with a difference in pixel value are set to 1 and the pixels with no difference in pixel value are set to 0 such that the block formed by the pixels with the value of 1 is the moving object.

According to the face area recognition method in the preferred embodiment of the present invention, the method further includes using a face recognition method to perform a face detection of the face block so as to determine the location of a face.

According to the face area recognition method in the preferred embodiment of the present invention, the face recognition method includes the following steps. First, a face characteristic data table that includes a plurality of characteristic blocks is established. Then, blocks having characteristics corresponding to these characteristic blocks are searched in the face blocks. Finally, those blocks that pass a comparison test with the characteristic blocks are recognized as a face.

According to the face area recognition method in the preferred embodiment of the present invention, the method further includes tracking a face according to the location of the face. The step for tracking a face includes finding a plurality of characteristic features of a face area, selecting the characteristic features near the center of the face as tracking targets, and comparing with the locations of the characteristic features in two consecutive images, thereby tracking the movement of the face accordingly.

According to the face area recognition method in the preferred embodiment of the present invention, the step for determining the skin color pixels from the other pixels includes turning all the remaining pixels in the image, aside from the skin color pixels, to black color pixels.

According to the face area recognition method in the preferred embodiment of the present invention, the constituent colors includes red (R), green (G) and blue (B). The method of determining the skin color pixels includes taking pixels having R value>G value>B value as the skin pixels, or taking the pixels having the R value exceeding the G value by a definite amount as the skin color pixels.

According to the face area recognition method in the preferred embodiment of the present invention, the step for comparing the skin color block with the ellipse includes the following steps. First, a plurality of edge points of the skin color block are found. Then, the edge points are compared with a plurality of peripheral points of the ellipse and the number of edge points overlapping the peripheral points is calculated. Next, the number of edge points is divided by the total number of peripheral points to obtain a ratio. Thereafter, the location of the ellipse is moved to calculate a plurality of ratios of the ellipse at different locations. Finally, the block enclosed by the ellipse with the largest ratio is selected as the face block.

According to the face area recognition method in the preferred embodiment of the present invention, the step of comparing the skirt color block and the ellipse further includes changing the size of the ellipse and moving the location of the ellipse to calculate the ratios between ellipsis having different sizes and different locations.

According to the face area recognition method in the preferred embodiment of the present invention, the ratio between the short axis and the long axis of the ellipse includes 1:1.2.

According to the face area recognition method in the preferred embodiment of the present invention, after the step of finding the skin color block in the image, further includes finding the smallest rectangular block that covers the skin color block to serve as a searching bock and adjusting the size and location of the ellipse in the searching block so as to perform the ellipse comparison.

The present invention combines the methods of skin color recognition and ellipse recognition and only uses the skin color block of the image for recognition. According to the characteristic that the shape of a human face is close to an ellipse, the area belonging to human face in the image is rapidly found through a comparison with an ellipse so that the effect of face area recognition is enhanced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram of a method for recognizing a face area according to a preferred embodiment of the present invention.

FIG. 2 is a diagram illustrating a target block according to a preferred embodiment of the present invention.

FIG. 3 is a diagram illustrating a skin color block according to a preferred embodiment of the present invention.

FIG. 4 is a diagram illustrating an ellipse sample according to a preferred embodiment of the present invention.

FIG. 5 is a flow diagram showing a method of comparing a skin color block and an ellipse according to a preferred embodiment of the present invention.

FIG. 6 is a diagram illustrating some characteristic blocks according to a preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In most applications related to facial characteristic detection, the image of the face area only occupies a small portion of the entire image and the remaining portion (including part of the body) may be regarded as the background and simply ignored. The present invention utilizes this characteristic and eliminates the need for recognizing the background portion of the image. Therefore, recognition is performed only on those areas in the image whose color matches the skin color standard. Furthermore, through a comparison with an ellipse, the speed for recognizing a face area is accelerated.

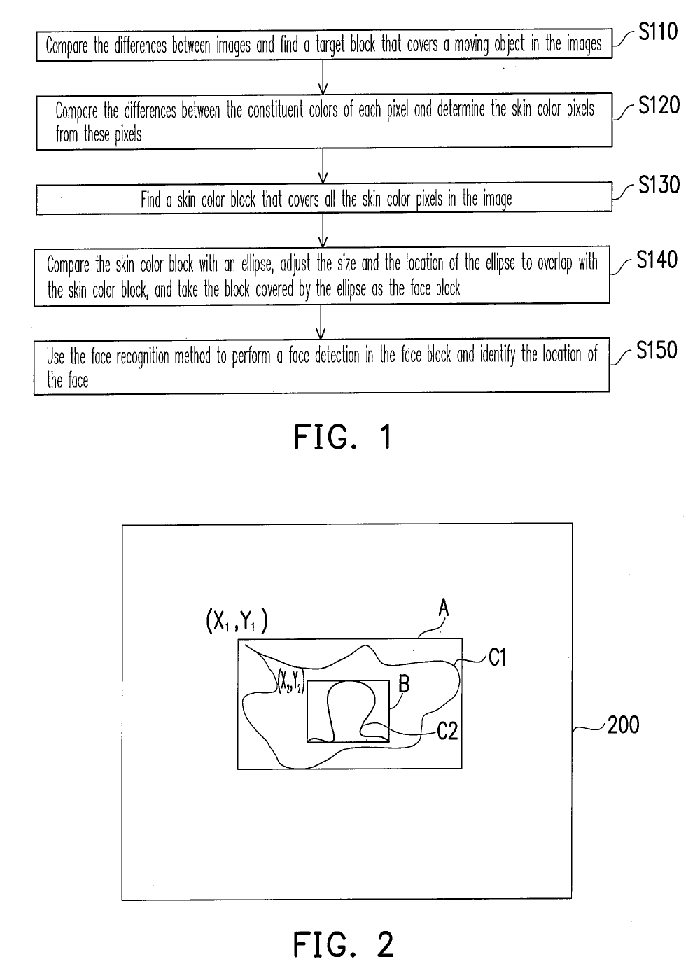

FIG. 1 is a flow diagram of a method for recognizing a face area according to a preferred embodiment of the present invention. As shown in FIG. 1, the present embodiment determines a face block from a plurality of images, wherein each image has a plurality of pixels. The method for recognizing a face area includes the following steps.

In a series of consecutively captured images, if only a single object moves therein and the background portion remains in a static state, the difference in the background portion between any two images is almost zero. Accordingly, the present invention first compares foregoing images to detect any differences and finds a smallest rectangular block that covers a moving object among the images to serve as a target block (step S110). In the method of finding the moving object, the pixel values of corresponding pixels in two adjacent images are subtracted with each other, and through a threshold process, the pixels with a difference in the pixel value are set to 1 and the pixels without a difference in the pixel value are set to 0. Hence, the block formed by the pixels set to 1 can be regarded as the moving object.

In the process of defining the target block in the present embodiment, the smallest rectangular block that covers all the pixels of the moving object is searched in the area extending from the edge of the moving object and used as the target block. However, this does not limit the present invention. A block of any other shape can be used as long as the block is able to cover the moving object. For example, FIG. 2 is a diagram illustrating a target block according to a preferred embodiment of the present invention. As shown in FIG. 2, the area enclosed by the curve C1 represents the moving object in the image 200 and the block A(x1, y1, width1, height1) is the smallest rectangular block that covers the moving object as defined by the present embodiment. Here, (x1, y1) represent the coordinates of the leftmost and uppermost point of the block A, and (width1, height1) represent the width and height of the block A. In fact, the coordinates (x1, y1) are obtained in a calculation using the pixel at the leftmost and uppermost corner of the image 200 as the reference point (0,0).

After finishing the search in the target block, the differences of the constituent colors of each pixel in the image are compared so that a plurality of skin color pixels are determined from the pixels (step S120). The aforementioned constituent colors may include, for example, red (R), green (G) and blue (B) or other kinds of constituent colors, and there is no particular limitation on the color range.

The foregoing method of determining the skin color pixels can be sub-divided into a plurality of sub-steps. First, the pixel value of each pixel in the moving object block (including R, G and B value) may be standardized into R′, G′ and B′ value using the following conversion formulas, and then the R′, G′ and B′ values are used to calculate the f1 and f2 values:

$$\begin{matrix}{R}^{′} = \frac{R}{R + G + B} , {G}^{′} = \frac{G}{R + G + B} , {B}^{′} = \frac{B}{R + G + B} ; & ( a ) \\ f 1 = - 1.376 {{R}^{′}}^{2} + 1.0743 {R}^{′} + 0.2 ; & ( b ) \\ f 2 = - 0.776 {R}^{′2} + 0.5601 {R}^{′} + 0.18 ; & ( c )\end{matrix}$$

Then, each of the foregoing parameters is substituted into the following decision formulas to determine if they match the skin color of a face:

f2<G′<f1; (d)

R′>G′>B′; (e)

(R′−0.33)²+(G′−0.33)>0.001; (f)

R−G≦5; (g)

In the present embodiment, all the foregoing decision formulas must be satisfied before the pixel is regarded as a pixel belonging to the skin color of a face. According to the foregoing formulas, the method of determining the skin color pixel in the present embodiment includes selecting those pixels having R value>G value>B value (for example, formula (e)) and selecting those pixels with the R value exceeding the G value by a predefined amount (for example, the formula (g)) as the skin color pixels. In addition, the formula (f) is further used to eliminate those pixels in the image very close to pure white color so that the remaining pixels can be readily identified as skin color pixels.

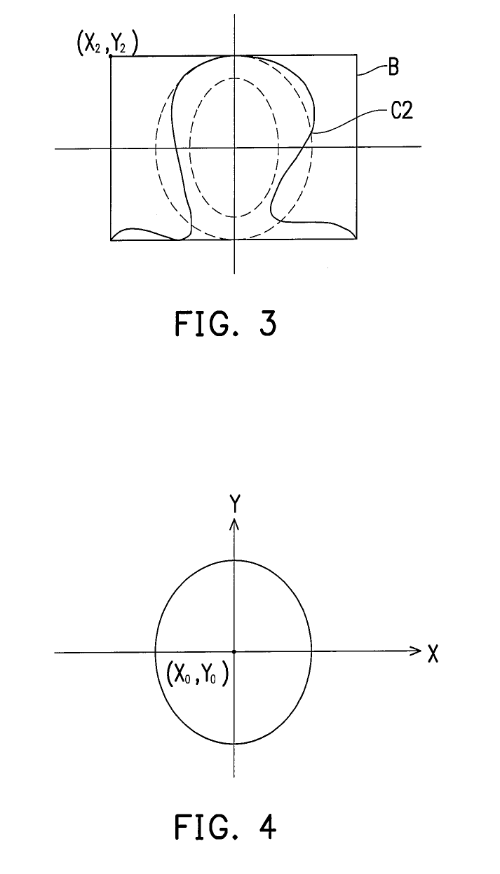

After recognizing the skin color pixels, the next step is to find the skin color block in the image that covers all the skin color pixels (step S130). As shown in FIG. 2, the skin color block in the present embodiment is the image block enclosed by the curve C2. Furthermore, after identifying the skin color block, the present embodiment further includes searching for the smallest rectangular block that covers the skin color block in the image to serve as a searching block for subsequently comparing with an ellipse. For example, FIG. 3 is a diagram illustrating a skin color block according to a preferred embodiment of the present invention. As shown in FIG. 3, it is assumed that the portion enclosed by the curve C2 represents a skin color block formed by the skin color pixels, then the block B(x2, y2, width2, height2) is the smallest rectangular block that covers the skin color block. Therefore, the block B is identified as a searching block. Here, (x2, y2) represents the leftmost and uppermost coordinates of the block B, and (width2, height2) represents the width and the height of the block B respectively.

It should be noted that, in order to determine the difference between the face area and the background area more reliable, the present embodiment also includes retaining the area that covers the skin color pixels while turning the area having the other non-skin color pixels into a pure black color (that is, an image value of zero). This has the merit of simplifying the subsequent step of comparing with an ellipse.

After identifying the skin color block, the present embodiment allows the range for facial recognition to be reduced from the entire image to only the image enclosed by the skin color block. From observing the image of a face, the face appears elliptical under most conditions, even when the face is turned to one side. Accordingly, the present embodiment compares the skin color block with an ellipse and adjusts the size and location of the ellipse within the foregoing range of the searching block to overlap the skin color block such that the block covered by the ellipse is regarded as a face block (step S140). In this way, the searching area for face recognition is further reduced.

FIG. 4 is a diagram illustrating an ellipse sample according to a preferred embodiment of the present invention. As shown in FIG. 4, the short axis and long axis x and y determines the size and shape of the ellipse. Because the distance of a face from the camera may affect the size of the face in the image, the size of the sample ellipse must be adjusted to compare with face area having different size. According to the ratio of a face, the ratio between the short axis and the long axis of the ellipse is approximately 1:1.2. However, the present invention does not restrict this ratio. Anyone skilled in the art may adjust the ratio according to the actual requirements.

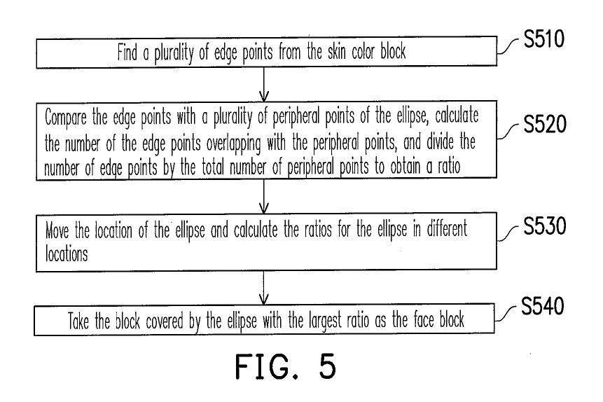

According to the foregoing description, the step for comparing the skin color block with the ellipse may be further divided into a plurality of sub-steps. FIG. 5 is a flow diagram showing a method of comparing a skin color block and an ellipse according to a preferred embodiment of the present invention. As shown in FIG. 5, the present embodiment first calculates a plurality of edge points (step S510) around the skin color block (that is, the area enclosed by the curve C2 in FIG. 3). Then, the edge points are compared with the peripheral points (x_{θ}, y_{θ}) of a plurality of ellipses calculated using the following formula (step S520):

x_{θ}=x₀+x×cos θ

y_{θ}=y₀+1.2x×sin θ

wherein, the foregoing peripheral points (x_{θ}, y_{θ}) are the peripheral points of ellipses using the central point (x₀, y₀) of the skin color block as the center and taking different values of x and θ such that 0≦x<0.5width2, 0°≦θ<360°. In the comparing process of the present embodiment, the number of edge points overlapping with the peripheral points (x_{θ}, y_{θ}) is counted using a counter. After dividing this number by the total number of peripheral points, a ratio is obtained. For example, when the edge points are compared with the ellipses (for example, x=0.25width2), if an edge point is lain on a peripheral point (x_{θ}, y_{θ}) of the ellipse, the counter is incremented by one. After the value of θ has changed from 0° to 360°, the total number of edge points lying on the periphery of the ellipse is obtained from the count in the counter. The ratio is obtained after dividing the number of edge points by the total number of peripheral points (x_{θ}, y_{θ}).

In the next step, the location of the ellipse is moved and then the foregoing method is used to calculate the number of overlapping edge points and the value of the ratio for the ellipse (step S530). The method of moving the location of the ellipse includes, for example, moving the central point location of the ellipse from the left upper corner of the searching block either horizontally or vertically without restricting its range. Aside from moving the location of the ellipse, the size of the ellipse may be changed and the location of the ellipse may be moved so that the ratios of ellipses having different sizes and at different locations are calculated.

Finally, the sizes of these ratios are compared and the area block covered by the ellipse with the largest ratio is taken as the face block (step S540). This ellipse with the largest ratio can be regarded as the block in the image most similar to the skin color block. Therefore, the present embodiment uses the area block covered by this ellipse as a face block.

After finding the elliptical block most similar to the skin color lock, the face recognition method can be used to initiate a face detection of the face block so that the location of the face can be determined (step S150). The face recognition method may be divided into the following steps.

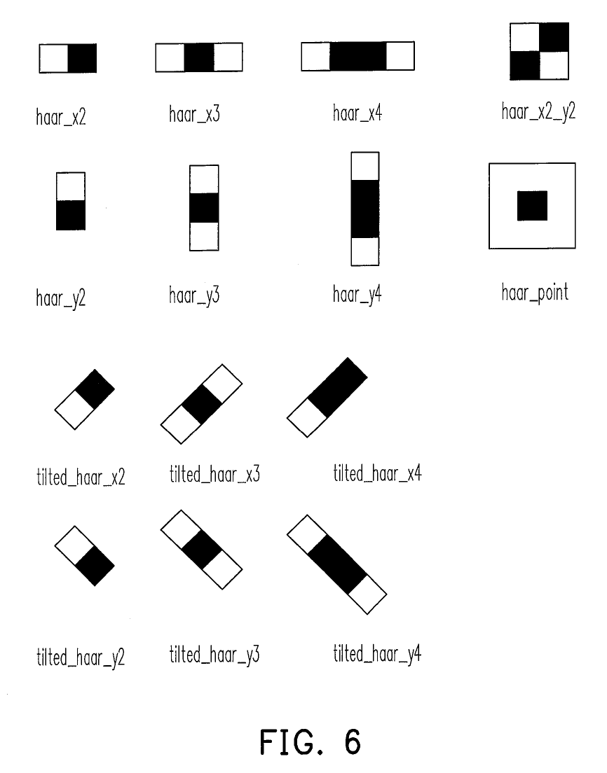

First, a face characteristic data table is set up. In the data table, the data of a plurality of characteristic blocks are included. The face characteristic data table is formed after going through multiple stages of comparison so that an area closest to the characteristic of a face is found from the image and used as the face characteristic block. FIG. 6 is a diagram illustrating some characteristic blocks according to a preferred embodiment of the present invention. As shown in FIG. 6, these characteristic blocks includes edge characteristics (including haar_x2, haar_x3, haar_x4, haar_x2_y2, haar_y2, haar_y3, haar_y4), line segment characteristics (including titled_haar_x2, titled_haar_x3, titled_haar_x4, titled_haar_y2, titled_haar_y3, titled_haar_y4) and a central-surrounding characteristic (haar_point). These characteristic blocks are disposed on a 20×20 or 24×24 size window, and following the magnification of the window, the portion of the face block most similar to the characteristic blocks is searched. Finally, the area blocks that pass the characteristic block comparison are determined to be a portion of the face.

After finding the location of the face, the present invention further includes using an image tracking scheme to track the movement of the face in the image. For example, a light flow method may be used to find a plurality of characteristic points in the face area and then a camera is used to capture an image in each time interval. After obtaining the characteristic points from the first image, the corresponding characteristic points of the series of images coming after can be transferred one after another so that all the characteristic points are found. Then, the characteristic points near the central portion of the face may be selected as the target for tracking. By comparing the sum of the relative distances between these characteristic points with the sum of the relative distances between the characteristic points of the previous image, the errors in between are controlled within a definite range and the purpose of continuously tracking the location of a face is achieved.

In summary, the method for recognizing a face area of the present invention has at least the following advantages:

1. By filtering the skin colors, there is no need to perform an image-wise search of the original image so that the time required for processing pixel comparisons is significantly reduced

2. The ellipse comparing method is able to find the face blocks by changing only the size and the location of the ellipse. Since there is no need to perform sophisticated calculations, computational resources are saved.

3. By simultaneously combining skin colors and ellipse filtering, the search area for face recognition is efficiently reduced and the accuracy of face recognition is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of recognizing a face area suitable for recognizing a face block from a plurality of images, wherein each image comprises a plurality of pixels, comprising:
comparing differences between a plurality of constituent colors of each pixel and determining a plurality of skin color pixels from the pixels;
finding a skin color block that covers all of the skin color pixels from the image; and
comparing the skin color block with an ellipse, adjusting the size and location of the ellipse to overlap the skin color block and taking the block covered by the ellipse as the face block.

2. The face area recognition method of claim 1, wherein, before the step of determining the skin color pixels, further comprising:
comparing the differences between the images and finding a smallest rectangular block that covers a moving object in the images as a target block; and
determining the skin color pixels from the pixels in the target block.

3. The face area recognition method of claim 2, wherein the step of finding the moving object according to the differences between the images comprising:
subtracting the pixel values of corresponding pixels in two adjacent images; and
using a threshold method to determine those pixels having a difference in pixel value as the moving object.

4. The face area recognition method of claim 3, wherein the threshold method comprises setting those pixels with a difference in pixel value to 1 and those pixels with no difference in pixel value to 0 such that the block of pixels set to 1 is regarded as the moving object.

5. The face area recognition method of claim 1, further comprising:
using a face recognition method to perform a face detection of the face block and find the location of a face.

6. The face area recognition method of claim 5, wherein the face recognition method comprising:
setting a face characteristic data table having a plurality of characteristic blocks;
searching the blocks corresponding to the characteristic blocks in the face block; and
regarding those blocks that pass the comparison with the characteristic blocks as the face.

7. The face area recognition method of claim 5, further comprising:
tracking the face according to the location of the face.

8. The face area recognition method of claim 7, wherein the step of tracking the face comprising:
finding a plurality of characteristic points from the face area;
selecting the characteristic point near the central portion of the face as a tracking target; and
comparing the locations of the characteristic points in two consecutive images and tracking the face accordingly.

9. The face area recognition method of claim 1, wherein the step of determining the skin color pixels comprising:
setting all the remaining pixels in the images other than the skin color pixels into black color.

10. The face area recognition method of claim 1, wherein the constituent colors comprise red (R), green (G) and blue (B).

11. The face area recognition method of claim 10, wherein the method of determining the skin color pixel comprises taking those pixels with constituent colors having R value>G value>B value as the skin color pixels.

12. The face area recognition method of claim 10, wherein the method of determining the skin color pixel comprises taking those pixels with the value of the constituent color R exceeding the value of the constituent color G by a predetermined amount as the skin color pixels.

13. The face area recognition method of claim 1, wherein the step of comparing the skin color block with the ellipse comprising:
finding a plurality of edge points from the skin color block;
comparing the edge points with a plurality of peripheral points of the ellipse, calculating the number of edge points overlapping with the peripheral points, and dividing the number with the total number of peripheral points to obtain a ratio;
moving the ellipse to other locations to calculate the ratios when the ellipse is at different locations; and
taking the block covered by the ellipse with the largest ratio as the face block.

14. The face area recognition method of claim 13, wherein the step of comparing the skin color block and the ellipse further comprising:
changing the size of the ellipse and moving the location of the ellipse to calculate the ratios of ellipses of different sizes and at different locations.

15. The face area recognition method of claim 13, wherein the ratio between the short axis and the long axis of the ellipse is about 1:1.2.

16. The face area recognition method of claim 1, wherein, after finding the skin color block from the images, further comprising:
finding a smallest rectangular block that covers the skin color block as a searching block; and
adjusting the size and the location of the ellipse within the searching block to perform the ellipse comparison.
